(19) United States
(12) Patent Application Publication
(10) Pub. No.: US 2026/0109424 A1
(43) Pub. Date: Apr. 23, 2026

(54) FOLDABLE SCOOTER

(71) Applicant: Radical Sportech LLC, Taipei City (TW)

(72) Inventor: Neil Owen, Dongguan City (CN)

(21) Appl. No.: 18/918,258

(22) Filed: Oct. 17, 2024

(51) Int. Cl. B62K 15/00

(52) U.S. Cl. CPC B62K 15/008

(57) ABSTRACT

A foldable scooter is provided, wherein the foldable scooter includes: a main body including a deck and at least one first wheel; a steering bar rotatably disposed on the main body with at least one second wheel thereon, including a first rod portion including two pivot walls and a second rod portion including a connection end portion rotatably connected to the two pivot walls, at least one of the two pivot walls including at least one locking slot; and an operation mechanism including a movable member and at least one key disposed on the movable member, the movable member being disposed on the second rod portion and axially slidable; wherein the at least one key can be engaged within the at least one locking slot to lock the steering bar or be disengaged from the at least one locking slot to unlock the steering bar.

### BACKGROUND OF THE INVENTION

### Field of the Invention

The present invention relates to a scooter, particularly to a foldable scooter.

### Description of the Prior Art

Scooters are very common devices of transportation in today's daily life. In order to facilitate portability and storage, its size is reduced as much as possible, so telescopic and foldable structures have been developed. For example, the folding structure of existing scooters is often provided on a larger-sized steering bar or deck, thereby significantly reducing the overall size.

Taking the existing steering bar as an example, it includes two rod members which are pivotally connected to each other at a radial side and interlocked at another radial side, thereby achieving a foldable function. However, when this structure is folded, a large gap will be generated between the two rod members, which can easily pinch the operator. In addition, it is only connected and fixed at two points in the radial direction, so its structural strength is poor and it does not have anti-loosing and/or locking mechanisms, which is easy to loosen and has safety concerns.

The present invention is, therefore, arisen to obviate or at least mitigate the above-mentioned disadvantages.

### SUMMARY OF THE INVENTION

The main object of the present invention is to provide a foldable scooter which has a simple structure, is easy and quick to fold, is reliable in locking, and ensures good reliability and safety.

To achieve the above and other objects, a foldable scooter is provided, wherein the foldable scooter includes: a main body including a deck and at least one first wheel disposed on the deck; a steering bar rotatably disposed on the main body with at least one second wheel connected to an end thereof, and including a first rod portion and a second rod portion, the first rod portion including two pivot walls arranged oppositely, at least one of the two pivot walls including at least one locking slot, the second rod portion including a connection end portion rotatably connected to the two pivot walls; and an operation mechanism including a movable member and at least one key, the movable member being disposed on the second rod portion and axially slidable along the second rod portion between a locking position and a release position, the at least one key being disposed on the movable member; wherein when the movable member is in the locking position, the at least one key is engaged within the at least one locking slot so that the connection end portion is unrotatable relative to the two pivot walls, and when the movable member is in the release position, the at least one key is disengaged from the at least one locking slot so that the connection end portion is rotatable relative to the two pivot walls.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a partial enlarged view of FIG. 2;

FIG. 4 is a cross-sectional view of an exemplary embodiment of the present invention;

FIG. 5 is a partial enlarged view of FIG. 4;

FIGS. 6 to 8 are drawings showing the folding operation of a foldable scooter of an exemplary embodiment of the present invention;

FIGS. 9 and 10 are drawings showing the folded state of the foldable scooter of an exemplary embodiment of the present invention;

FIG. 11 is a partial enlarged view of FIG. 10; and

FIG. 12 is a partial exploded view of an exemplary embodiment of the present invention.

### DETAILED DESCRIPTION OF THE PREFERRED EMBODIMENTS

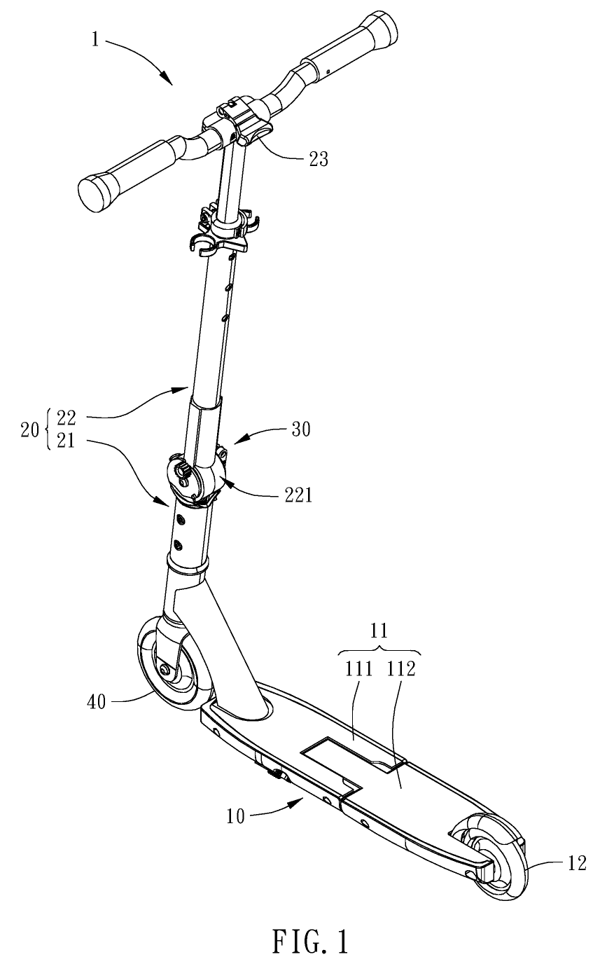

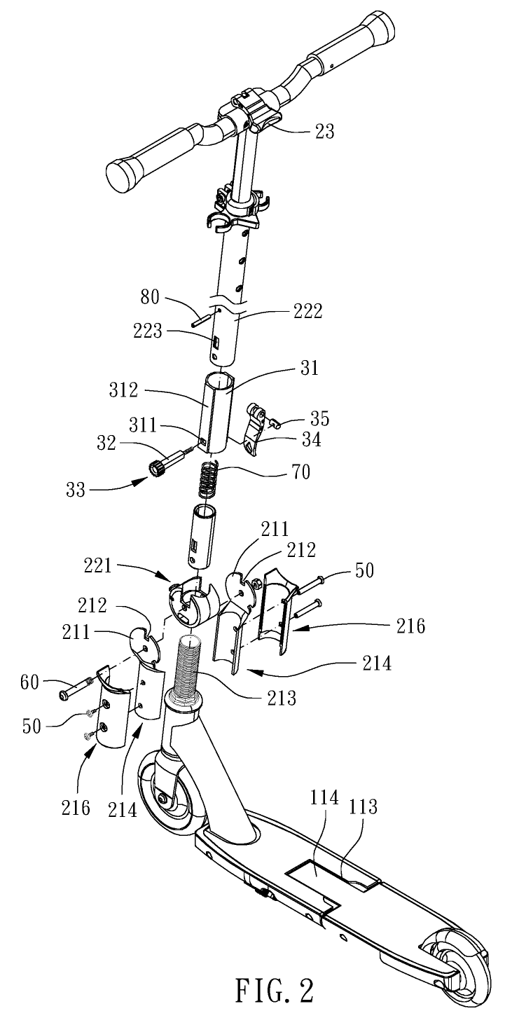

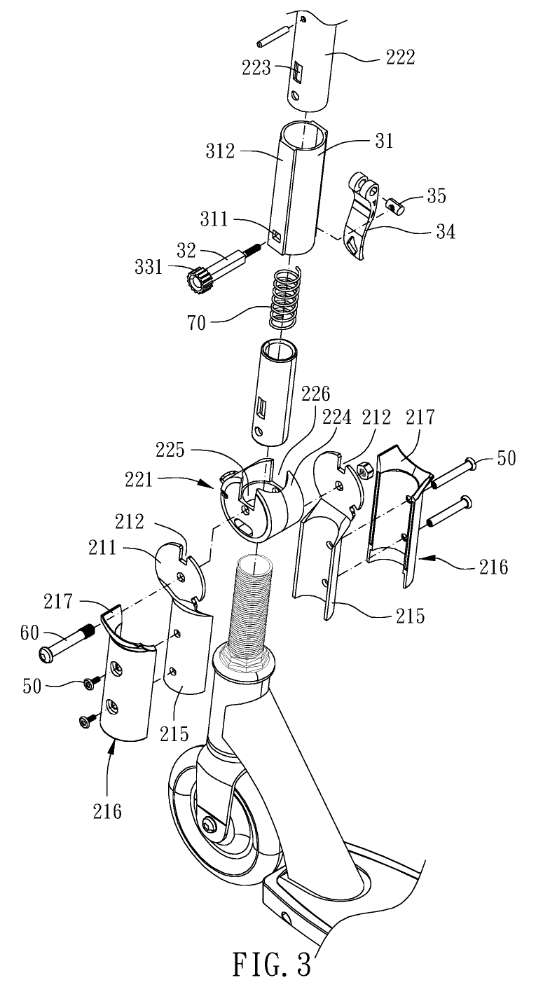

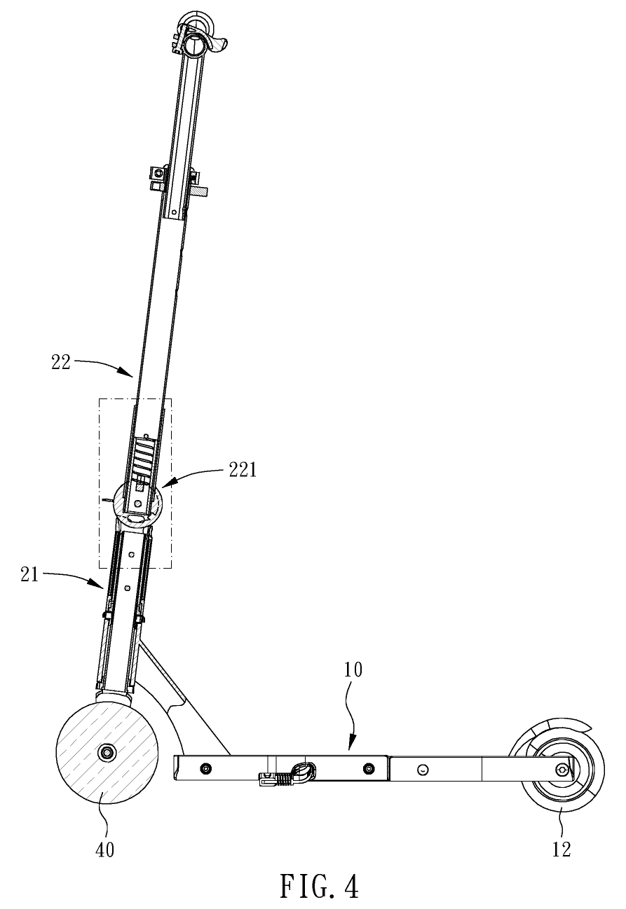

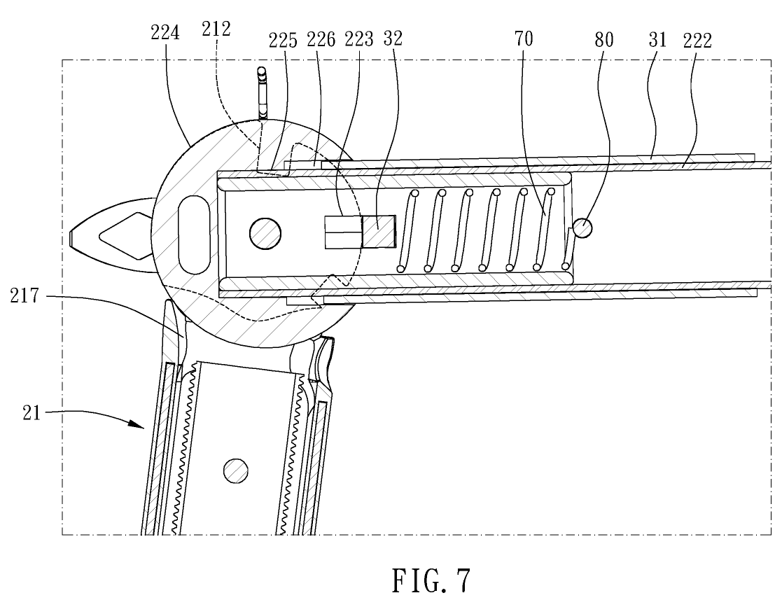

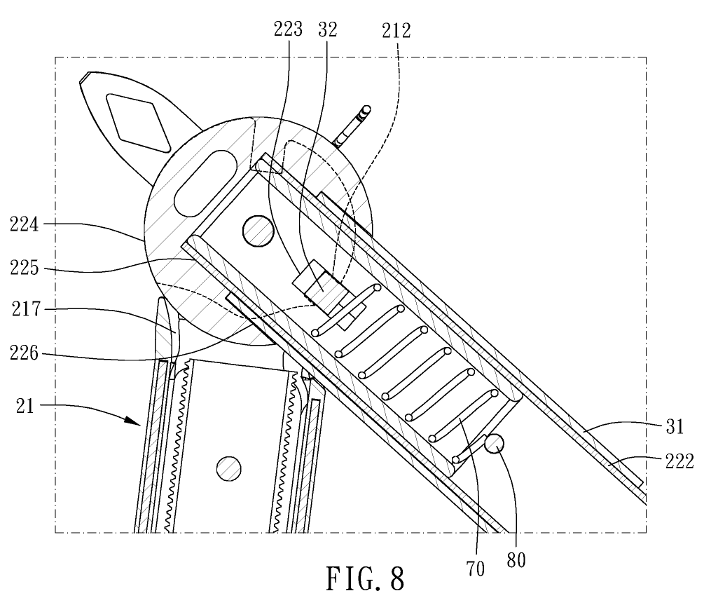

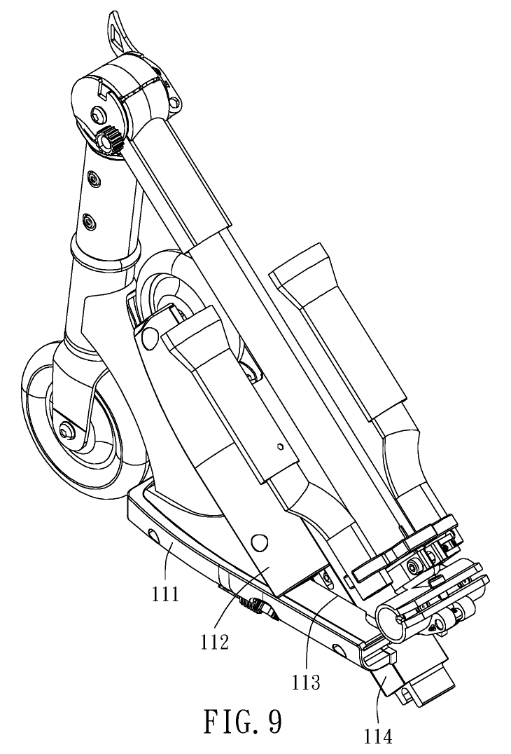

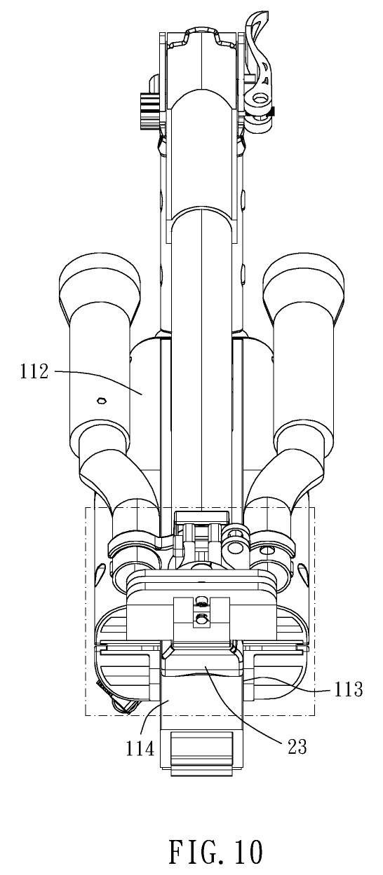

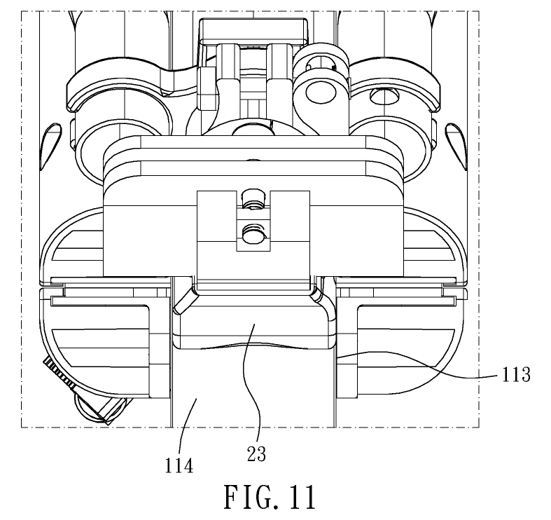

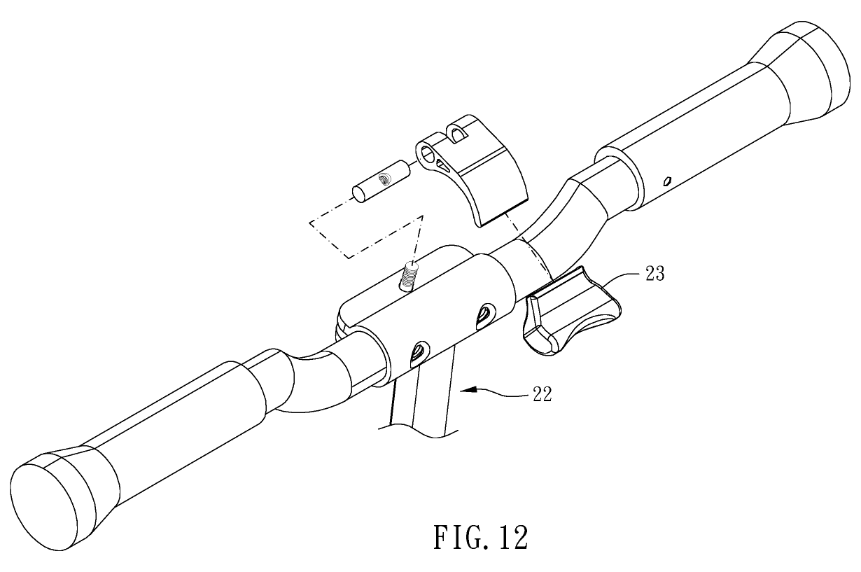

Please refer to FIGS. 1 to 12 for an exemplary embodiment of the present invention. A foldable scooter 1 of the present invention includes a main body 10, a steering bar 20, and an operation mechanism 30.

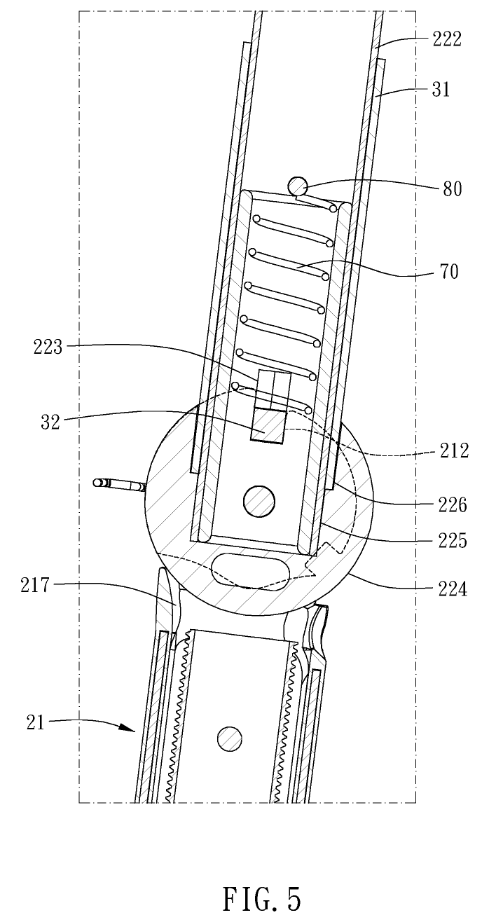

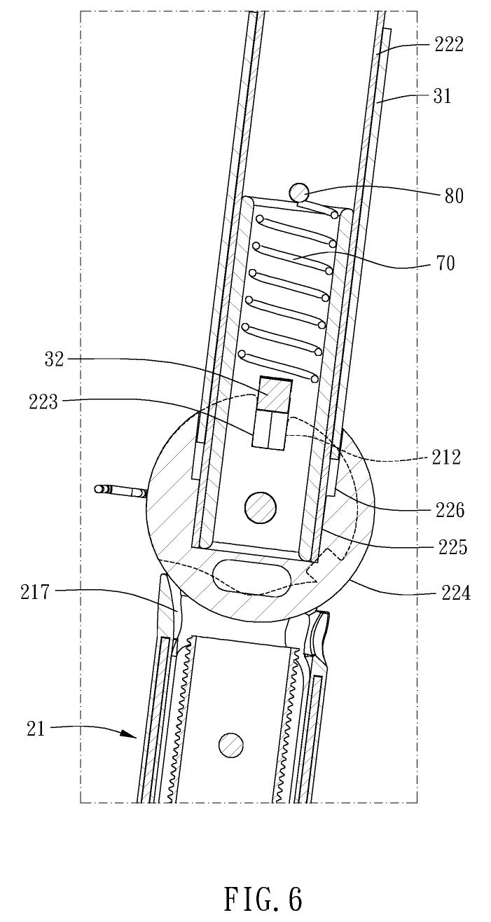

The main body 10 includes a deck 11 and at least one first wheel 12 disposed on the deck 11. The steering bar 20 is rotatably disposed on the main body 10 with at least one second wheel 40 connected to one end. The steering bar 20 includes a first rod portion 21 and a second rod portion 22. The first rod portion 21 includes two pivot walls 211 arranged oppositely, and at least one of the pivot walls (preferably both) includes at least one locking slot 212. The second rod portion 22 includes a connection end portion 221 rotatably connected to the two pivot walls 211. The operation mechanism 30 includes a movable member 31 and at least one key 32. The movable member 31 is disposed on the second rod portion 22 and is axially slidable along the second rod portion 22 between a locking position (FIG. 5) and a release position (FIG. 6). The at least one key 32 is disposed on the movable member 31. When the movable member 31 is in the locking position, the at least one key 32 is engaged within the at least one locking slot 212, preventing relative rotation between the connection end portion 221 and the two pivot walls 211. When the movable member 31 is in the release position, the at least one key 32 is disengaged from the at least one locking slot 212, allowing relative rotation between the connection end portion 221 and the two pivot walls 211. Thus, the structure is simple, the folding operation is quick and convenient, and the locking is reliable, ensuring good reliability and safety.

In this embodiment, the first rod portion 21 forms the lower section of the steering bar 20. In other possible embodiments, the first rod portion 21 may form the upper section of the steering bar 20. The first rod portion 21 further includes a first rod member 213 and two attachment members 214, which are fixedly connected (may be detachably connected) to the first rod member 213. Each attachment member 214 includes one of the pivot walls 211. Additionally, each attachment member 214 includes an arcuate shell portion 215 connected to the pivot wall 211 and fixed to the first rod member 213. These two attachment members 214 are independent components, making them convenient for assembly, disassembly, replacement, and maintenance. Preferably, the first rod portion 21 further includes two curved shell members 216, which are stacked on the arcuate shell portions 215 of the two attachment members 214 and are fixed (may be detachably connected) to the first rod member 213 by at least one fastener 50. The top ends of the two curved shell members 216 abut against the two pivot walls 211, supporting the two attachment members 214 and enhancing the overall structural strength.

The second rod portion 22 further includes a second rod member 222, which is inserted into the connection end portion 221. A pivot member 60 penetrates and connects the two pivot walls 211, the connection end portion 221, and the second rod member 222. The movable member 31 is tubular and sleeved onto the second rod member 222. The movable member 31 includes a through hole 311, and the second rod member 222 includes a guide groove 223. The at least one key 32 is disposed through the through hole 311 and the guide groove 223 and can be driven by the movable member 31 to slide along the guide groove 223. The outer side of the movable member 31 further includes a rib 312, and the through hole 311 is opened on the rib 312, which strengthens the structural integrity of the movable member 31. Preferably, the foldable scooter 1 further includes an elastic member 70, which may be disposed between the operation mechanism 30 and the pivot member 60, or between the operation mechanism 30 and the second rod member 222 (such as a pin 80), allowing the movable member 31 to automatically return to the locking position after operation.

The connection end portion 221 includes an outer circumferential surface 224, an insertion slot 225, and at least one notch 226 (preferably a plurality of notches). The outer circumferential surface 224 extends arcuately around the pivot member 60, and the insertion slot 225 is radially recessed inward from the outer circumferential surface 224. The at least one notch 226 axially penetrates the end surface of the connection end portion 221 and is radially open at one end. The second rod member 222 is inserted into the insertion slot 225, making assembly, disassembly, and maintenance convenient, while providing greater structural strength. When the movable member 31 is in the locking position, the at least one key 32 is located within the at least one notch 226, providing stable support and strong restriction to the at least one key 32.

Preferably, the first rod portion 21 further includes an end structure 217. The end structure 217 extends arcuately relative to the pivot member 60. The end structure 217 faces and matches the shape of the outer circumferential surface 224 of the connection end portion 221, effectively reducing the gap between components, facilitating smooth rotation, and providing good support. The end structure 217 may be formed on the two curved shell members 216, on the two attachment members 214, or simultaneously on both the two attachment members 214 and the two curved shell members 216.

The operation mechanism 30 further includes a shaft 33, a lever 34, and an axle 35. The shaft 33 is axially movable and disposed through the movable member 31 and the second rod portion 22. The at least one key 32 is disposed on the shaft 33, wherein the at least one key 32 and the shaft 33 may be integrally formed of one piece or assembled with each other. An end of the shaft 33 includes an enlarged head 331 which may be threadedly connected, and the enlarged head 331 is blocked outside one of the pivot walls 211. The axle 35 is inserted in the lever 34 and connected (screwed, for example) to an other end of the shaft 33. The lever 34 is swingable around the axle 35 to releasably urge the two pivot walls 211, allowing the two pivot walls 211 to abut against the two opposite sides of the connection end portion 221, thereby enhancing the locking reliability. Preferably, the portion of the shaft 33 that includes the at least one key 32 is non-circular (rectangular, for example), and the through hole 311 of the movable member 31 is also non-circular, preventing the shaft 33 from rotating and ensuring the stability of the locking mechanism.

In this embodiment, the deck 11 includes a first portion 111 and a second portion 112, which are rotatably connected to each other. An upper end portion of the steering bar 20 is provided with a limitation block 23, which is preferably made of flexible materials such as rubber, plastic, silicone, etc. An end of the first portion 111 includes a connection slot 113, and an end of the second portion 112 includes a protruding section 114, with the protruding section 114 being housed in the connection slot 113. When the deck 11 is folded, the protruding section 114 extends transversely within the connection slot 113, and when the steering bar 20 is folded toward the deck 11, the limitation block 23 is positioned within the connection slot 113 and outside the second portion 112. Preferably, the width of the limitation block 23 can be greater than, equal to or slightly smaller than the width of the connection slot 113, effectively maintaining the folded structure and preventing shaking. This design can avoid damage to the foldable section, prevent collisions between components, and reduce noise from collisions.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A foldable scooter including:
a main body including a deck and at least one first wheel disposed on the deck;
a steering bar rotatably disposed on the main body with at least one second wheel connected to an end thereof, and including a first rod portion and a second rod portion, the first rod portion including two pivot walls arranged oppositely, at least one of the two pivot walls including at least one locking slot, the second rod portion including a connection end portion rotatably connected to the two pivot walls; and
an operation mechanism including a movable member and at least one key, the movable member being disposed on the second rod portion and axially slidable along the second rod portion between a locking position and a release position, the at least one key being disposed on the movable member;
wherein when the movable member is in the locking position, the at least one key is engaged within the at least one locking slot so that the connection end portion is unrotatable relative to the two pivot walls, and when the movable member is in the release position, the at least one key is disengaged from the at least one locking slot so that the connection end portion is rotatable relative to the two pivot walls.

2. The foldable scooter of claim 1, wherein the first rod portion includes a first rod member and two attachment members, the two attachment members are fixedly connected to opposing sides of the first rod member, and each of the two attachment members includes one of the two pivot walls.

3. The foldable scooter of claim 2, wherein each of the two attachment members further includes an arcuate shell portion, and the arcuate shell portion is connected to one of the two pivot walls and fixedly connected to the first rod member.

4. The foldable scooter of claim 3, wherein the first rod portion further includes two curved shell members, each of the two curved shell members is stacked with the arcuate shell portion of one of the two attachment members and fixedly connected to the first rod member by at least one fastener.

5. The foldable scooter of claim 1, wherein the second rod portion further includes a second rod member, the second rod member is inserted in the connection end portion, and a pivot member penetrates and connects the two pivot walls, the connection end portion and the second rod member.

6. The foldable scooter of claim 5, wherein the movable member is tubular and sleeved on the second rod member, the movable member includes a through hole, the second rod member includes a guide groove, the at least one key is disposed through the through hole and the guide groove, and the at least one key is slidable along the guide groove.

7. The foldable scooter of claim 6, wherein the connection end portion includes an outer circumferential surface, an insertion slot and at least one notch, the outer circumferential surface extends arcuately around the pivot member, the insertion slot is radially recessed inwardly from the outer circumferential surface, the at least one notch axially penetrates an end surface of the connection end portion and is radially open at one end, the second rod member is inserted in the insertion slot, and when the movable member is in the locking position, the at least one key is located within the at least one notch.

8. The foldable scooter of claim 7, wherein the first rod portion further includes an end structure, the end structure arcuately extends relative to the pivot member, and the end structure faces the outer circumferential surface of the connection end portion and matches a shape of the outer circumferential surface of the connection end portion.

9. The foldable scooter of claim 1, wherein the operation mechanism further includes a shaft, a lever and an axle, the shaft is axially movable and disposed through the movable member and the second rod portion, the at least one key is disposed on the shaft, an end of the shaft includes an enlarged head, the enlarged head is blocked outside one of the two pivot walls, the axle is inserted in the lever and connected to an other end of the shaft, and the lever is swingable around the axle to releasably urge the two pivot walls.

10. The foldable scooter of claim 1, wherein the deck includes a first portion and a second portion which are rotatably connected to each other, a limitation block is disposed on an upper end portion of the steering bar, an end of the first portion includes a connection slot, an end of the second portion includes a protruding section, when the deck is folded, the protruding section extends transversely within the connection slot, and when the steering bar is folded toward the deck, the limitation block is located within the connection slot and outside the second portion.
